(19) United States
(12) Patent Application Publication
(10) Pub. No.: US 2005/0287413 A1
(43) Pub. Date: Dec. 29, 2005

(54) Separator for fuel cell, method of preparing same, and fuel cell comprising same

(76) Inventors: Jun-Won Suh, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/159,496

(22) Filed: Jun. 21, 2005

(30) Foreign Application Priority Data
Jun. 23, 2004 (KR) 10-2004-0047024

(51) Int. Cl. H01M 2/00

(52) U.S. Cl. 429/34; 429/129

(57) ABSTRACT

The separator of the present invention includes a substrate with a flow path channel formed thereon, and a hydrophobic coating layer formed in the flow path channel. The separator for a fuel cell, which is suggested in the present invetnion, can easily discharge water generated at a cathode because the hydrophobic coating layer is formed only in the flow path channel.

### CROSS REFERENCE TO RELATED APPLICATION

This application claims priority to and the benefit of Korean Patent Application No. 10-2004-0047024 filed in the Korean Intellectual Property Office on Jun. 23, 2004, the content of which is incorporated hereinto by reference.

### FIELD OF THE INVENTION

The present invention relates to a separator for a fuel cell, a preparation method thereof, and a fuel cell comprising the same. More particularly, it relates to a separator for a fuel cell that can discharge water easily, a preparation method thereof, and a fuel cell comprising the separator.

### BACKGROUND OF THE INVENTION

A fuel cell is a device for generating electricity directly from an electrochemical reaction of hydrogen included in hydrocarbon materials such as methanol, ethanol, and natural gas, and oxygen.

The fuel cell can be classified into one of the following types: a phosphoric acid type, a fused carbonate type, a solid oxide type, a polymer electrolyte type, or an alkaline type of fuel cell depending upon the kind of electrolyte used. Although each fuel cell basically operates in accordance with the same basic principles, the type of fuel cell may determine the kind of fuel, the operating temperature, the catalyst, and the electrolyte.

Recently, polymer electrolyte membrane fuel cells (PEMFC) have been developed which have superior power characteristics to those of conventional fuel cells, a lowered operating temperature, and start and response characteristics which are more rapid. It has advantages since it can be applied to a wide range of fields such as a transportable electric source for an automobile, a distributed power source such as for a house and a public building, and a small electric source for an electronic device.

The polymer electrolyte fuel cell is essentially composed of a stack, a reformer, a fuel tank, and a fuel pump for the basic system. The stack forms a body, and the fuel pump provides fuel stored in the fuel tank to the reformer. The reformer reforms the fuel to generate hydrogen gas and supplies the hydrogen gas to the stack. Accordingly, the polymer electrolyte fuel cell provides the fuel stored in the fuel tank to the reformer using the fuel pump. Then, the reformer reforms the fuel to generate hydrogen gas and the hydrogen gas is electrochemically reacted with oxygen in the stack to generate electric energy.

A stack, which substantially generates electricity in a fuel cell system, has a structure where a plurality of unit cells, each having a membrane electrode assembly (MEA) and separators placed to contact both sides of the membrane electrode assembly, are stacked with each other. The fuel cell system includes several to scores of unit cells. The membrane electrode assembly has a structure where an anode and a cathode are attached to each other with a polymer electrolyte membrane between them. The separators separate membrane electrode assemblies from each other, and perform a role of a path for providing hydrogen gas and oxygen needed for reactions in a fuel cell to the anode and the cathode of each membrane electrode assembly, respectively, and a role of a conductor for connecting the anode and the cathode of the membrane electrode assembly in series.

Therefore, the anode receives hydrogen gas through a separator, and the cathode receives oxygen through a separator. During the process, an oxidation reaction of the hydrogen gas is caused at the anode, and a reduction reaction of the oxygen occurs at the cathode. Herein, electricity is generated by the flow of electrons generated from the reactions, and heat and water are generated as byproducts.

### SUMMARY OF THE INVENTION

It is an aspect of the present invention to provide a separator for a fuel cell that can easily discharge water which is generated during the operation of the fuel cell.

It is another aspect of the present invention to provide a fuel cell including the separator.

To achieve the aspects, the present invention provides a separator for a fuel cell, which includes a substrate having a flow path channel formed thereon, and a hydrophobic coating layer formed in the flow path channel.

The present invention further provides a fuel cell which includes at least one membrane electrode assembly including an anode and a cathode facing each other and a polymer electrolyte membrane placed between the anode and the cathode, and a separator with a flow path channel for supplying fuel or gas in contact with either of the anode and the cathode of the membrane electrode assembly, wherein the separator includes a substrate, and a hydrophobic coating layer is formed in the flow path channel.

### BRIEF DESCRIPTION OF THE DRAWINGS

The accompanying drawings, which are incorporated in and constitute a part of the specification, illustrate embodiments of the invention, and together with the description, serve to explain the principles of the invention, wherein:

FIG. 1 is a cross-sectional view showing a separator in accordance with an embodiment of the present invention;

FIG. 2 is a schematic view illustrating operation of the fuel cell including the separator of the present invention; and

FIG. 3 is a graph describing cell characteristics of fuel cells including separators of Example 1 and Comparative Example 1 of the present invention, individually.

### DETAILED DESCRIPTION OF THE EMBODIMENTS

In the following detailed description, the following embodiments of the invention have been shown and described, simply by way of illustration of the best mode contemplated by the inventors of carrying out the invention. As will be realized, the invention is capable of modification in various respects, all without departing from the invention. Accordingly, the drawings and description are to be regarded as illustrative in nature, and not restrictive.

The present invention provides separators which separate a plurality of membrane electrode assemblies from each other and provide a path for hydrogen gas and oxygen needed for reactions in a fuel cell to the anode and the cathode of the membrane electrode assembly, respectively, and act as a conductor for connecting the anode and the cathode of the membrane electrode assembly in series.

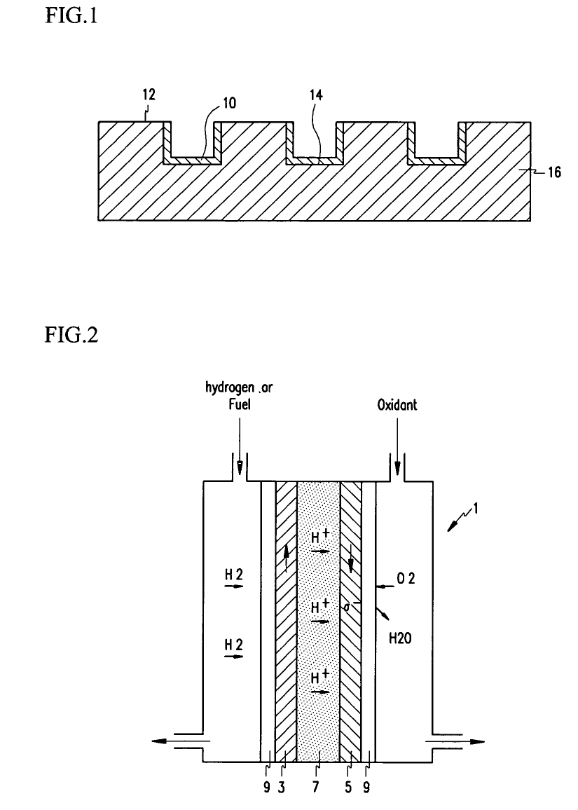

The separators should have a strong corrosion-resistance and no gas permeability. Also, they should be able to discharge water generated at the cathode electrode during the operation of the fuel cell very well. In the present invention, a hydrophobic coating layer is formed only in flow path channels of the separators in order to discharge water very well. As shown in FIG. 1, only the inside of the flow path channel 14 of the separators is coated with the hydrophobic coating layers 10, and ribs 12 are not coated. In short, the separator of the present invention includes a substrate 16 with flow path channels 14 formed thereon and hydrophobic coating layers 10 formed in the flow path channels 14.

The substrate 16 can be formed of one selected from the group consisting of metal, graphite, and carbon-resin complex. As for the metal, one selected from the group consisting of stainless steel, aluminum, titanium, and copper can be used, but the present invention is not limited to these. As for the carbon-resin complex, a complex of a resin selected from the group consisting of an epoxy-based resin, an ester-based resin, a vinyl ester-based resin, and a urea resin, with carbon such as graphite, can be used.

The hydrophobic coating layer 10 is formed by coating only the flow path channel of the substrate with a fluorine-based resin composition. The fluorine-based resin composition includes polytetrafluoroethylene, polyvinylidene fluoride, and fluorinated ethylene propylene (FEP). The fluorine-based resin composition can use such solvents as N-methyl-2-pyrrolidone and dimethyl acetamide. It can also be used in the form of emulsion by being dispersed in water with the use of a surface active agent having both a hydrophobic group and a hydrophilic group at the same time. The coating process can be performed by any method as long as the method can selectively coat only the flow path channel with the fluorine-based resin composition.

The optimal thickness of the hydrophobic coating layer 10 is 1 to 100 μm. If the hydrophobic coating layer is thinner than 1 μm, the hydrophobic coating layer is fatigued due to repeated thermal expansion and compression by changes in temperature caused upon operation/suspension of a fuel cell, and thus the hydrophobic coating layer can be peeled off. If the thickness of the hydrophobic coating layer exceeds 100 μm, there is a problem that the separators become too thick.

Since the separators of the present invention described above are coated with the hydrophobic coating layer only in the flow path channel and not in the part that contact the membrane electrode assembly, they can discharge water generated during the operation of the fuel cell effectively and prevent the physical characteristics of the fuel cell from degradation.

The separators of the present invention can be usefully used in the fuel cell. FIG. 2 shows operation of the fuel cell 1 including an anode 3, a cathode 5, a polymer electrolyte membrane 7, and separators 9. The anode 3 and the cathode 5 include a catalyst layer in which a metal catalyst participating in the electrochemical reaction is supported by carbon. Preferably, the separators having the hydrophobic coating layer are used as separators contacting the anode.

In the fuel cell, hydrogen, or fuel, is supplied to the anode 3 and an oxidant, preferably oxygen, is supplied to the cathode 5 to thereby generate electricity through the electrochemical reactions at the anode and the cathode. In other words, an oxidation reaction of organic fuel occurs at the anode 3, and a reduction reaction of the oxidant is caused at the cathode 5 to thereby generate a voltage difference between the two electrodes.

The membrane electrode assembly is formed by placing the polymer electrolyte membrane between the anode and the cathode, and a stack is formed by using membrane/electrode assemblies. Then, the fuel cell can be prepared by interpolating the stack between two end plates. The fuel cell can be assembled easily according to conventional technology of the field of the present invention.

The catalyst layer for the electrode according to the present invention can be selected from, but is not limited to, the group consisting of platinum, ruthenium, osmium, a platinum-ruthenium alloy, a platinum-osmium alloy, a platinum-palladium alloy, and a platinum-M alloy (M is at least one selected from the group consisting of Ga, Ti, V, Cr, Mn, Fe, Co, Ni, Cu, and Zn). Preferably, it is at least one catalyst selected from the group consisting of platinum, ruthenium, osmium, a platinum-ruthenium alloy, a platinum-osmium alloy, a platinum-palladium alloy, a platinum-cobalt alloy, and a platinum-nickel alloy.

The polymer electrolyte membrane is composed of a proton-conductive polymer material, that is, an ionomer. The proton-conducting polymer may be selected from the group consisting of perfluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers, and polyphenylquinoxaline-based polymers. In a preferred embodiment, at least one proton-conducting polymer may include but is not limited to a polymer selected from the group consisting of poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), and poly(2,5-benzimidazole). According to the present invention, a proton-conducting polymer included in a polymer electrolyte membrane for a fuel cell is not limited to these polymers. The polymer electrolyte membrane has a thickness ranging from 10 to 200 μm.

The membrane electrode assembly is formed by placing the polymer electrolyte membrane between the anode and the cathode, and a stack is formed by using multiple membrane electrode assemblies. Then, the fuel cell can be prepared by interpolating the stack between two end plates. The fuel cell can be assembled easily according to conventional technology of the field of the present invention.

The separators of the present invention can be preferably applied to a direct oxidation fuel cell, such as a direct methanol fuel cell.

The following examples further illustrate the present invention in detail, but they are not to be construed to limit the scope thereof.

### EXAMPLE 1

A separator was prepared by coating only the flow path channel with a polytetrafluoroethylene fluorine-based resin composition in a stainless steel substrate with the flow path channel formed thereon.

### EXAMPLE 2

A separator was prepared by the same method as in Example 1, except that polyvinylidene fluoride resin was used as the fluorine-based resin.

### COMPARATIVE EXAMPLE 1

Stainless steel with a flow path channel formed thereon was used as a separator.

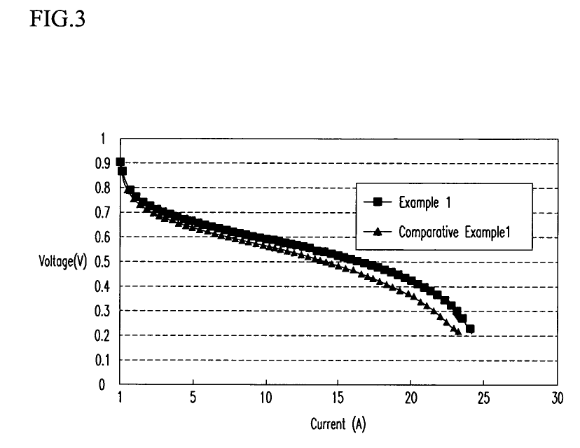

Currents and voltages of fuel cells using the separators of Example 1 and Comparative Example 1, respectively, were measured and are shown in FIG. 3. As shown in FIG. 3, the current and voltage of the fuel cell using the separator of Example 1 which has a hydrophobic coating layer formed only in the flow path channel were better than those of Comparative Example 1.

The separator for a fuel cell of the present invention has a hydrophobic coating layer formed only in the flow path channel and thus can discharge water generated in a cathode and render the reaction of the fuel cell to be smooth.

While the present invention has been described in detail with reference to the preferred embodiments, those skilled in the art will appreciate that various modifications and substitutions can be made thereto without departing from the spirit and scope of the present invention as set forth in the appended claims.

1. A separator for a fuel cell, comprising:
a substrate having a flow path channel formed thereon; and
a hydrophobic coating layer formed in the flow path channel.

2. The separator of claim 1, wherein the hydrophobic coating layer includes a fluorine-based resin.

3. The separator of claim 2, wherein the fluorine-based resin is selected from the group consisting of polytetrafluoroethylene, polyvinylidene fluoride, and fluorinated ethylene propylene (FEP).

4. The separator of claim 1, wherein the substrate is selected from the group consisting of metal, graphite, and a carbon-resin complex.

5. The separator of claim 4, wherein the metal is selected from the group consisting of stainless steel, aluminum, titanium, and copper.

6. A fuel cell, comprising
at least one membrane electrode assembly including an anode and a cathode facing each other and a polymer electrolyte membrane placed between the anode and the cathode, and
a separator with a flow path channel for supplying fuel or gas in contact with either of the anode and the cathode of the membrane electrode assembly,
wherein the separator includes a substrate and a hydrophobic coating layer formed in the flow path channel.

7. The fuel cell of 6, wherein the hydrophobic coating layer includes a fluorine-based resin.

8. The fuel cell of claim 7, wherein the fluorine-based resin is selected from the group consisting of polytetrafluoroethylene, polyvinylidene fluoride, and fluorinated ethylene propylene (FEP).

9. The fuel cell of claim 6, wherein the substrate is selected from the group consisting of metal, graphite, and a carbon-resin complex.

10. The fuel cell of claim 9, wherein the metal is selected from the group consisting of stainless steel, aluminum, titanium, and copper.

11. The fuel cell of claim 6, which is direct oxidation fuel cell.

12. The fuel cell of claim 9, wherein the separator on which a hydrophobic coating layer is formed contacts an anode.
